(19) United States
(12) Patent Application Publication
(10) Pub. No.: US 2026/0313607 A1
(43) Pub. Date: Oct. 8, 2026

(54) MANAGEMENT OF SL RELATED BANDWIDTH INFORMATION FOR ENABLING SL POSITIONING

(71) Applicant: Telefonaktiebolaget LM Ericsson (publ), Stockholm (SE)

(72) Inventors: lana SIOMINA, TABY (SE); Mohammed LYAZIDI, LONDON (GB); Florent MUNIER, VASTRA FROLUNDA (SE)

(21) Appl. No.: 19/482,953

(22) PCT Filed: Apr. 30, 2024
(86) PCT No.: PCT/EP2024/061866

§ 371 Date: Nov. 10, 2025

Related U.S. Application Data
(60) Provisional application No. 63/465,617, filed on May 11, 2023.

(51) Int. Cl. H04W 64/00; H04W 72/25; H04W 72/51

(52) U.S. Cl. CPC H04W 64/006; H04W 72/25; H04W 72/51

(57) ABSTRACT

Various embodiments disclosed herein provide for management of sidelink (SL) related bandwidth information for enabling SL positioning. Positioning nodes can receive SL related bandwidth information from at least one of radio network nodes or from User Equipments (UEs) and then perform SL positioning operation based on the information. The SL related bandwidth information is obtained in response to sending a request for the information. The positioning node can be in another UE, or some other network node. Radio network nodes can also provide the SL related bandwidth information, which they obtain from UEs or other radio network nodes, to the positioning nodes in response to receiving requests for the information. UEs also provide the information as well as control interruptions in the UE due to a mismatch between SL related bandwidth information and uplink bandwidth related information.

### CROSS-REFERENCE TO RELATED APPLICATION(S)

This application claims priority to the provisional U.S. patent application No. 63/465,617, entitled “METHODS TO MANAGE SL BANDWIDTH INFORMATION TO ENABLE SL POSITIONING IN NG-RAN”, filed on May 11, 2023, which is incorporated herein by reference in its entirety.

### TECHNICAL FIELD

The present disclosure relates to the field of telecommunications, and in particular, to management of sidelink (SL) related bandwidth information for enabling SL positioning.

### BACKGROUND

### Positioning in NR

New Radio (NR) architecture is illustrated in FIG. 1, where New Radio Base Station (gNB) 108 and ng-eNB 106 (or evolved eNB) denote NR base stations (BSs) (one NR BS may correspond to one or more transmission/reception points, TRPs) in a Radio Access Network (RAN) 104 and the lines between the nodes illustrate the corresponding interfaces.

Location management function (LMF) 110 and optionally Evolved Serving Mobile Location Centre (E-SMLC) 114 are the location nodes or positioning servers in NR. There are also interactions between the location node and the gNB 108 via the NR positioning protocol annex (NRPPa) (not illustrated in FIG. 1) and the Access and Mobility Management Function (AMF) 112 and between User Equipment (UE) 102-1 and the location server via Long Term Evolution (LTE) positioning protocol (LPP), which is also used in NR. The interactions between the gNB and the UE are supported via the Radio Resource Control (RRC) protocol.

Note 1: The gNB 108 and ng-eNB 106 may not always both be present.

Note 2: When both the gNB 108 and ng-eNB 106 are present, the NG-C interface is only present for one of them.

### SL Operation and SL Positioning

The sidelink (SL) operation enables direct communication on the SL or PC5 interface between two or more UEs. The UEs can be both in-coverage with respect to a radio access network, both out-of-coverage, or in a mixed coverage scenario with at least one UE in-coverage and at least one UE out-of-coverage. Device to Device (D2D) is another term for SL operation. The D2D operation is a generic term which may comprise transmission and/or reception of any type of D2D signals (e.g., physical signals, physical channel etc.) by a D2D communication capable UE and/or by D2D discovery capable UE on a SL. Vehicle to Everything (V2X) is a special type of device to device (D2D) operation, with a vehicle being involved. In LTE, proximity services are referred to as ProSe.

For SL transmissions (including radio signals for SL positioning), there are two modes of resource allocations:
Mode 1: SL resources are scheduled by a network node e.g., gNB.
   For positioning, mode 1 is referred to as “Scheme 1”, which includes the mode 1 functionality together with positioning specific enhancements.
Mode 2: The UE autonomously selects SL resources from a (pre-) configured SL resource pool(s) based on the channel sensing mechanism.
   For positioning, mode 2 is referred to as “Scheme 2”, which includes the mode 2 functionality together with positioning specific enhancements.

The in-coverage UE can be configured by a network node (e.g., gNB) to use Mode 1/Scheme 1 or Mode 2/Scheme 2 resource allocation mechanism. The out-of-coverage UE can only use Mode 2/Scheme 2 resource allocation mechanism.

SL positioning is being standardized now in 3GPP for Rel-18 NR.

FIG. 2 presents the SL positioning architecture in Rel-18 that is considered as baseline. In addition to the elements present in FIG. 1, FIG. 2 also shows additional UEs 102-2, and 102-3, as well as SL positioning nodes 202 present in each of the UEs, LMF 110 (e.g., positioning nodes 202-1, 202-2, 202-3, and 202-4) as well as a SL positioning node 116 present in the core network.

SL positioning measurements performed by a target UE are used for determining position/location of that target UE. The target UE performs an SL positioning measurement on SL reference signals (e.g., SL Positioning Reference Signal (PRS) or SL Sounding Reference Signal (SRS)) transmitted by one or more other (anchor) UEs and/or on SL reference signals (e.g., SL PRS or SL SRS) transmitted by the target UE itself.

Examples of the considered SL positioning measurements are:
SL Rx-Tx time difference or Round Trip Time (RTT) measurement (can be defined as T_{SL-RX}-T_{SL-TX}, where T_{SL-RX} is the received timing of a SL time resource #i from an anchor UE, and T_{SL-TX} is the transmit timing of SL time resource #j closest in time to the time resource #i received from the anchor UE).
SL RSTD (Reference Signal Time Difference) measurement (SL reference signal time difference between two anchor UEs i.e., between an anchor UE i and a reference anchor UE j).
SL RSRP measurement (SL PRS reference signal received power, SL PRS-RSRP or SL RSRP, is the linear average over the power contributions (in [W]) of the resource elements that carry SL PRS reference signals).
SL RSRPP measurement (SL PRS reference signal received path power, SL PRS-RSRPP or SL RSRPP, is the linear average of the channel response at the i^{th} path delay of the of the resource elements that carry SL PRS reference signals; SL RSRPP for the 1^{st} path delay is the power contribution corresponding to the first detected path in time).
SL RTOA (Relative Time of Arrival) measurement (the beginning of SL time resource #i containing e.g., SL PRS received in the target UE, relative to a reference time e.g., the RTOA Reference Time.
SL Azimuth angle of Arrival (AoA) measurement (Azimuth angle of Arrival of e.g., SL PRS transmitted by the anchor UE and measured by the target UE).
SL Zenith angle of Arrival (ZoA) measurement (Zenith angle of Arrival of e.g., SL PRS transmitted by the anchor UE and measured by the target UE).
SL pathloss measurement (pathloss measurement based on SL positioning reference signals e.g., SL PRS or SL SRS).

SL positioning reference signal (PRS) is similar to Downlink (DL) PRS used for positioning measurement in the Wide Area Network (WAN) (i.e., over Uu interface). The numerologies of the SL PRS are limited to those defined for SL operation. Maximum PRS Bandwidth (BW) is 272 Physical Resource Blocks (PRBs). Minimum PRS BW is 24 PRBs. The configured PRS BW is always a multiple of 4.

SL UE transmissions and receptions must be contained within SL bandwidth part (SL BWP) and employ the same numerology. SL BWP is a (generally) smaller part of the carrier bandwidth. In a carrier, only one SL BWP is (pre-) configured for all UEs. The SL BWP is divided into common RBs, consisting of 12 consecutive subcarriers with the same Sub-Carrier Spacing (SCS), where the SCS is given by the numerology of the SL BWP. The common Physical Resource Blocks (PRBs) are indexed within the SL BWP.

In NR Uu there can be up to four BWPs configured for the DL and Uplink (UL) of a UE, although only one BWP is active for the DL and one BWP is active for the UL at a time. For SL operation, there is only one SL BWP.
NOTE: if a (n in-coverage) UE has an active UL BWP, the SL BWP must use the same numerology as the UL BWP, otherwise the SL BWP is deactivated. This is due to the fact that in coverage SL is transmitted in UL slots.
   From TS 38.331 (RRC protocol, gNB→UE):
SL-FreqConfig
   The IE SL-FreqConfig specifies the dedicated configuration information on one particular carrier frequency for NR sidelink communication (note: maxNrofSL-BWPs-r16=1).

SL-FreqConfig information element

| | |
|---|---|
| SL-FreqConfig-r16 ::= | SEQUENCE { |
| sl-Freq-Id-r16 | SL-Freq-Id-r16, |
| sl-SCS-SpecificCarrierList-r16 | SEQUENCE (SIZE (1..maxSCSs)) OF SCS-SpecificCarrier, |
| sl-AbsoluteFrequencyPointA-r16 | ARFCN-ValueNR |

OPTIONAL, -- Need M

| | |
|---|---|
| sl-AbsoluteFrequencySSB-r16 | ARFCN-ValueNR |

OPTIONAL, -- Need R

| | |
|---|---|
| frequencyShift7p5khzSL-r16 | ENUMERATED {true} |

OPTIONAL, -- Cond V2X-SL-Shared

| | |
|---|---|
| valueN-r16 | INTEGER (−1..1), |
| sl-BWP-ToReleaseList-r16 | SEQUENCE (SIZE (1..maxNrofSL-BWPs-r16)) OF BWP-Id |

OPTIONAL, -- Need N

| | |
|---|---|
| sl-BWP-ToAddModList-r16 | SEQUENCE (SIZE (1..maxNrofSL-BWPs-r16)) OF SL-BWP- |

Config-r16 OPTIONAL, -- Need N

| | |
|---|---|
| sl-SyncConfigList-r16 | SL-SyncConfigList-r16 |

OPTIONAL, -- Need M

| | |
|---|---|
| sl-SyncPriority-r16 | ENUMERATED {gnss, gnbEnb} |

OPTIONAL -- Need M
}
sl-BWP-ToAddModList
This field indicates the list of sidelink BWP(s) on which the NR sidelink communication configuration is to be
added or reconfigured. In this release, only one BWP is allowed to be configured for NR sidelink
communication.
sl-BWP-ToReleaseList
This field indicates the list of sidelink BWP(s) on which the NR sidelink communication configuration is to be
released.

SL-FreqConfigCommon
   The IE FreqConfigCommon specifies the cell-specific configuration information on one particular carrier frequency for NR sidelink communication.

SL-FreqConfigCommon information element

-- ASN1START
-- TAG-SL-FREQCONFIGCOMMON-START

| | |
|---|---|
| SL-FreqConfigCommon-r16 ::= | SEQUENCE { |
| sl-SCS-SpecificCarrierList-r16 | SEQUENCE (SIZE (1..maxSCSs)) OF SCS-SpecificCarrier, |
| sl-AbsoluteFrequencyPointA-r16 | ARFCN-ValueNR, |
| sl-AbsoluteFrequencySSB-r16 | ARFCN-ValueNR |

OPTIONAL, -- Need R

| | |
|---|---|
| frequencyShift7p5khzSL-r16 | ENUMERATED {true} |

OPTIONAL, -- Cond V2X-SL-Shared

| | |
|---|---|
| valueN-r16 | INTEGER (−1..1), |
| sl-BWP-List-r16 | SEQUENCE (SIZE (1..maxNrofSL-BWPs-r16)) OF SL-BWP- |

ConfigCommon-r16 OPTIONAL, -- Need R

| | |
|---|---|
| sl-SyncPriority-r16 | ENUMERATED {gnss, gnbEnb} |

OPTIONAL, -- Need R

| | |
|---|---|
| sl-NbAsSync-r16 | BOOLEAN |

OPTIONAL, -- Need R

| | |
|---|---|
| sl-SyncConfigList-r16 | SL-SyncConfigList-r16 |

OPTIONAL, -- Need R
...
}
-- TAG-SL-FREQCONFIGCOMMON-STOP
-- ASN1STOP
sl-BWP-List
This field indicates the list of sidelink BWP(s) on which the NR sidelink communication configuration. In this
release, only one BWP is allowed to be configured for NR sidelink communication.

SL-BWP-Config
   The IE SL-BWP-Config is used to configure the UE specific NR sidelink communication on one particular sidelink bandwidth part.

SL-BWP-Config information element

-- ASN1START
-- TAG-SL-BWP-CONFIG-START

| | |
|---|---|
| SL-BWP-Config-r16 ::= | SEQUENCE { |
| sl-BWP-Id | BWP-Id, |
| sl-BWP-Generic-r16 | SL-BWP-Generic-r16 |

OPTIONAL, -- Need M

| | |
|---|---|
| sl-BWP-PoolConfig-r16 | SL-BWP-PoolConfig-r16 |

```
OPTIONAL, -- Need M
  ...,
  [[
```

| | |
|---|---|
| sl-BWP-PoolConfigPS-r17 | SetupRelease {SL-BWP-PoolConfig-r16} |

OPTIONAL, -- Need M

| | |
|---|---|
| sl-BWP-DiscPoolConfig-r17 | SetupRelease {SL-BWP-DiscPoolConfig-r17} |

OPTIONAL -- Need M
]]
}

| | |
|---|---|
| SL-BWP-Generic-r16 ::= | SEQUENCE { |
| sl-BWP-r16 | BWP |

OPTIONAL, -- Need M

| | |
|---|---|
| sl-LengthSymbols-r16 | ENUMERATED {sym7, sym8, sym9, sym10, sym11, sym12, |

sym13, sym14} OPTIONAL, -- Need M

| | |
|---|---|
| sl-StartSymbol-r16 | ENUMERATED {sym0, sym1, sym2, sym3, sym4, sym5, |

sym6, sym7} OPTIONAL, -- Need M

| | |
|---|---|
| sl-PSBCH-Config-r16 | SetupRelease {SL-PSBCH-Config-r16} |

OPTIONAL, -- Need M

| | |
|---|---|
| sl-TxDirectCurrentLocation-r16 | INTEGER (0..3301) |

OPTIONAL, -- Need M
...
}
-- TAG-SL-BWP-CONFIG-STOP
-- ASN1STOP

SL-BWP-ConfigCommon
   The IE SL-BWP-ConfigCommon is used to configure the cell-specific configuration information on one particular sidelink bandwidth part.

SL-BWP-ConfigCommon information element

-- ASN1START
-- TAG-SL-BWP-CONFIGCOMMON-START

| | |
|---|---|
| SL-BWP-ConfigCommon-r16 ::= | SEQUENCE { |
| sl-BWP-Generic-r16 | SL-BWP-Generic-r16 |

OPTIONAL, -- Need R

| | |
|---|---|
| sl-BWP-PoolConfigCommon-r16 | SL-BWP-PoolConfigCommon-r16 |

```
OPTIONAL, -- Need R
  ...,
  [[
```

| | |
|---|---|
| sl-BWP-PoolConfigCommonPS-r17 | SL-BWP-PoolConfigCommon-r16 |

OPTIONAL, -- Need R

| | |
|---|---|
| sl-BWP-DiscPoolConfigCommon-r17 | SL-BWP-DiscPoolConfigCommon-r17 |

OPTIONAL -- Need R
]]
}
-- TAG-SL-BWP-CONFIGCOMMON-STOP
-- ASN1STOP

### SUMMARY

Various embodiments disclosed herein provide for a method for obtaining sidelink (SL) related bandwidth information at a positioning node to enable SL positioning in a wireless communication system. Positioning nodes can receive SL related bandwidth information from radio network nodes or from User Equipments (UEs) and then perform some SL positioning operation based on the information. The SL related bandwidth information can be obtained in response to sending a request for the information. The positioning node can be in another UE, or some network node such as a Location Management Function (LMF). Radio network nodes can also provide the SL related bandwidth information, which they (the radio network nodes) obtain from UEs or other radio network nodes, to the positioning nodes in response to receiving requests for the information. UEs can also provide the information as well as control interruptions in the UE due to a mismatch between SL related bandwidth information and uplink bandwidth related information.

In an embodiment, a method can be performed by a positioning node for obtaining SL related bandwidth information. The method can include receiving SL related bandwidth information from at least one of a radio network node or a UE. The method can also include configuring an operation for positioning based on the SL related bandwidth information.

In an embodiment, a positioning node can be provided that is configured for obtaining SL related bandwidth information. The positioning node can include processing circuitry configured to receive SL related bandwidth information from at least one of a radio network node or a UE and configure an operation for positioning based on the SL related bandwidth information.

In an embodiment, a method can be provided that is performed by a radio network node for providing SL related bandwidth information. The method can include providing the SL related bandwidth information to a network node wherein the network node is at least one of a positioning node or another radio network node.

In an embodiment, another method is provided that is performed by a radio network node for positioning based on SL related bandwidth information. The method can include receiving SL related bandwidth information from a network node, wherein the network node is at least one of a positioning node or another radio network node. The method can also include performing a network operation for positioning based on the SL related bandwidth information.

In an embodiment, a radio network node is provided for providing SL related bandwidth information. The radio network node can include processing circuitry configured to provide the SL related bandwidth information to a network node, wherein the network node is at least one of a positioning node or another radio network node.

In an embodiment, a radio network node is provided for positioning based on SL related bandwidth information. The radio network node can include processing circuitry configured to receive SL related bandwidth information from a network node, wherein the network node is at least one of a positioning node or another radio network node. The radio network node can also include processing circuitry configured to perform a network operation for positioning based on the SL related bandwidth information.

In an embodiment, a method performed by a UE is provided for providing SL related bandwidth information. The method can include determining to provide SL related bandwidth information to a node, wherein the node is one of another UE, a radio network node, a core network node, or a UE positioning node or a network positioning node. The method can also include providing the SL related bandwidth information to the node.

In an embodiment, a UE is provided for providing SL related bandwidth information. The UE can include processing circuitry configured to determine to provide SL related bandwidth information to a node, wherein the node is one of another UE, a radio network node, a core network node, or a UE positioning node or a network positioning node. The UE can also include processing circuitry configured to provide the SL related bandwidth information to the node.

In an embodiment, a method performed by a UE is provided for controlling interruptions in the UE due to a mismatch between SL related bandwidth configuration and uplink bandwidth related configuration. The method can include comparing SL related bandwidth configuration and uplink bandwidth related configuration. The method, in response to identifying a mismatch, can also include at least one of providing SL related bandwidth information to a node, performing an SL positioning operation while controlling an amount of interruptions to Uu operation associated with the UE, or performing a Uu operation while controlling an amount of interruptions to SL positioning operation associated with the UE.

In an embodiment, a UE is provided for controlling interruptions in the UE due to a mismatch between sidelink, SL, related bandwidth configuration and uplink bandwidth related configuration. The UE can include processing circuitry configured to: compare SL related bandwidth configuration and uplink bandwidth related configuration. The UE can also include processing circuitry configured to, in response to identifying a mismatch, perform at least one of: provide SL related bandwidth information to a node; perform an SL positioning operation while controlling an amount of interruptions to Uu operation associated with the UE; or perform a Uu operation while controlling an amount of interruptions to SL positioning operation associated with the UE.

An advantage of some embodiments disclosed herein is that positioning nodes, radio network nodes, UEs, and methods are provided to enable SL positioning session, based on the SL-related BW (e.g., SL BWP) information, which otherwise might not be possible.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 shows an example of New Radio (NR) positioning architecture in accordance with some embodiments of the present disclosure;

FIG. 2 shows an example of NR positioning architecture for sidelink (SL) positioning in accordance with some embodiments of the present disclosure;

FIG. 3 shows an example of a flow chart for a method performed by a positioning node for obtaining SL related bandwidth information in accordance with some embodiments of the present disclosure;

FIG. 4 shows an example of a flow chart for a method performed by a radio network node for providing SL related bandwidth information in accordance with some embodiments of the present disclosure;

FIG. 5 shows an example of a flow chart for a method performed by a radio network node for positioning based on SL related bandwidth information in accordance with some embodiments of the present disclosure;

FIG. 6 shows an example of a flow chart for a method performed by a User Equipment (UE) for providing SL related bandwidth information in accordance with some embodiments of the present disclosure;

FIG. 7 shows an example of a flow chart for a method performed by a UE for controlling interruptions due to a mismatch between SL related bandwidth information and uplink bandwidth related information in accordance with some embodiments of the present disclosure;

FIG. 8 shows an example of a communication system in accordance with some embodiments of the present disclosure;

FIG. 9 shows a User Equipment device (UE) in accordance with some embodiments of the present disclosure;

FIG. 10 shows a network node in accordance with some embodiments of the present disclosure;

FIG. 11 is a block diagram of a host, which may be an embodiment of the host of FIG. 8, in accordance with various aspects of the present disclosure described herein;

FIG. 12 is a block diagram illustrating a virtualization environment in which functions implemented by some embodiments of the present disclosure may be virtualized;

FIG. 13 shows a communication diagram of a host communicating via a network node with a UE over a partially wireless connection in accordance with some embodiments of the present disclosure;

FIG. 14 is a diagram illustrating an exemplary procedure for signaling SL related bandwidth information in accordance with some embodiments of the present disclosure; and

FIG. 15 is a diagram illustrating another exemplary procedure for signaling SL related bandwidth information in accordance with some other embodiments of the present disclosure.

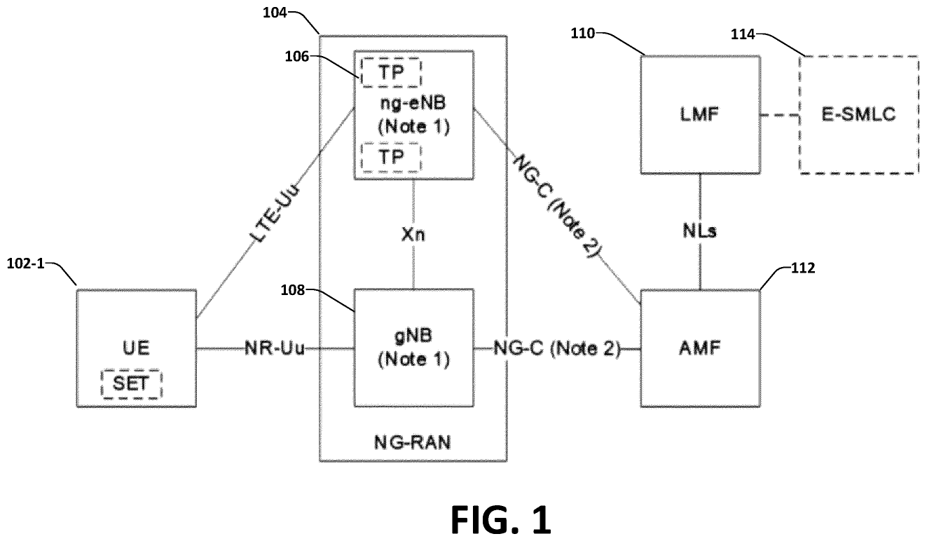

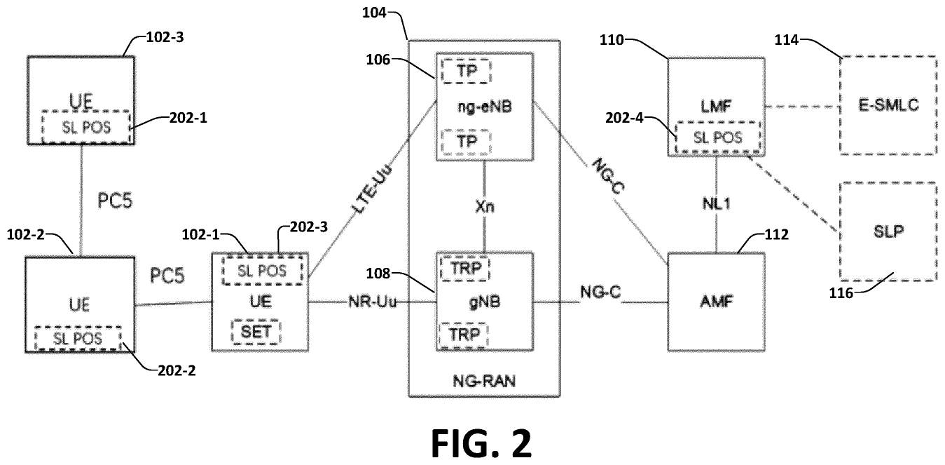

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Some of the embodiments contemplated herein will now be described more fully with reference to the accompanying drawings. Embodiments are provided by way of example to convey the scope of the subject matter to those skilled in the art.

There currently exist certain challenge(s).

Positioning node (e.g., LMF) is not a part of RAN and is generally not aware of SL UE BW (e.g., SL BWP and its associated parameters such as SRS, UE bandwidth capability, etc.). Without this information, it may be difficult to configure/control PRS resource pools.

A neighbor cell or base station (e.g., the serving cell of at least one second UE involved in SL positioning session, the target cell at handover of a first or second UE involved in an SL positioning session, etc.) may not be aware of the SL BWP of the first UE and its associated parameters, which may negatively impact the SL positioning session.

If a (n in-coverage) UE has an active UL BWP, the SL BWP must use the same numerology as the UL BWP, otherwise the SL BWP is deactivated, since SL transmissions need to be in UL slots. This may cause a negative impact on the SL positioning session in case of the lack of the bandwidth-related information at a network node or another UE involved in the same SL positioning session.

Certain aspects of the disclosure and their embodiments may provide solutions to these or other challenges.

Various embodiments disclosed herein provide for a method for obtaining sidelink (SL) related bandwidth information at a positioning node to enable SL positioning in a wireless communication system. Positioning nodes can receive SL related bandwidth information from radio network nodes or from User Equipments (UEs) and then perform some SL positioning operation based on the information. The SL related bandwidth information can be obtained in response to sending a request for the information. The positioning node can be in another UE, or some network node such as a Location Management Function (LMF). Radio network nodes can also provide the SL related bandwidth information, which they (the radio network nodes) obtain from UEs or other radio network nodes, to the positioning nodes in response to receiving requests for the information. UEs can also provide the information as well as control interruptions in the UE due to a mismatch between SL related bandwidth information and uplink bandwidth related information.

Some embodiments herein comprise at least one of methods in at least one of:
Positioning node (UE or network node):
   Positioning node (e.g., in UE or network node) sends a request message to a radio network node (e.g., to gNB via NRPPA) or UE (e.g., via SLPP or LPP), to obtain SL-related BW information.
   Positioning node obtains SL-related BW information, e.g., from a radio network node or UE.
   Positioning node uses the obtained SL-related BW information for SL positioning.
Radio network node:
   Radio network RN1 receives a request message for SL information from another network node (e.g., positioning node or another radio network node RN2).
   Radio network node RN1 provides SL-related BW information to another network node (e.g., positioning node and/or at least one another radio network node RN2).
   Radio network node RN1 provides an update for the SL-related BW information to another network node (e.g., positioning node and/or at least one another radio network node RN2).
   Radio network RN2 sends a request message for SL information to another network node (e.g., positioning node or another radio network node RN1).
   Radio network node RN2 receives SL-related BW information from another network node (e.g., positioning node or another radio network node RN1).
   Using the received SL-related BW information for positioning.
   Sending a message in response to the received SL-related BW information.
UE:
   A first UE determines a need to provide the SL-related BW information or its update to another node (e.g., to at least one second UE, radio network node, positioning node in a UE, or positioning node in the network).
   A first UE provides the SL-related BW information or its update to another node (e.g., to at least one second UE, radio network node, positioning node in a UE, or positioning node in the network) to enable SL positioning.

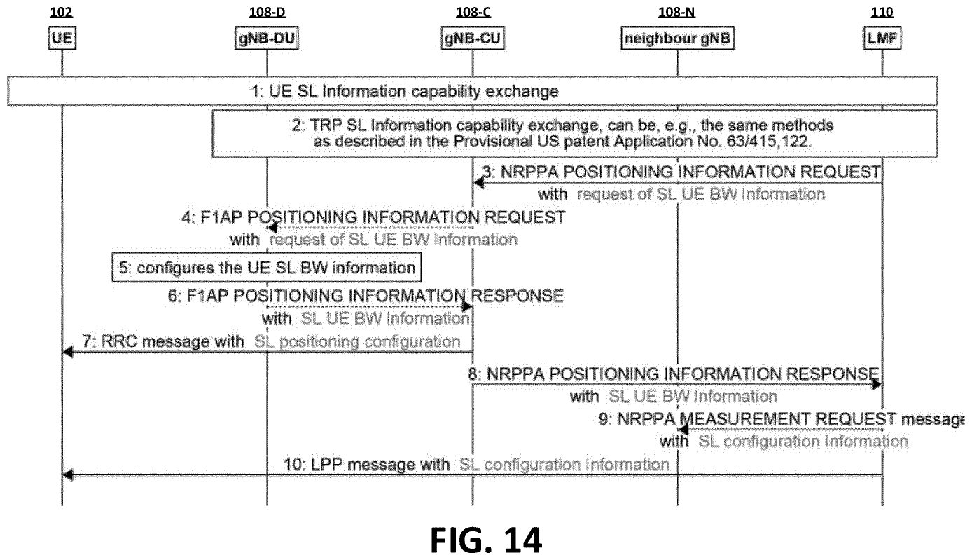

As shown at steps 3 and 4 in FIG. 14, the LMF 110 can request the gNB/TRPs 108 (e.g., a gNB including a gNB-CU 108-C and a gNB-DU 108-D) via a new request indicator to configure the UE 102 with SL configuration for positioning (e.g., at steps 5, 6, and 7) and to report the SL-related BW information associated to the UE 102 (e.g., at step 8).

The LMF 110 is aware of radio network node (RAN) 104 and TRPs support configuring SL BWPs via, e.g., the methods described in the Provisional Application U.S. 63/415,122, as shown at step 2 in FIG. 14.

The new request indicator is signalled over NRPPA from LMF 110 to gNB-CU 108-C at step 3 and from gNB-CU 108-C to gNB-DU 108-D over F1 signalling at step 4. The gNB-DU 108-D during or after the configuring the SL UE BW-related information at steps 5, 6, and 7, signals the SL UE BW-related information associated to this UE to higher layers, e.g., to gNB-CU 108-C and LMF 110 at steps 6 and 8, respectively.

The SL UE BW-related information is comprising at least one of SL BWP, SL UE BW capability, SL UE active BW configuration, BW configuration of SL resource pool, common resource blocks (RBs) of SL resource pool, etc.

Since the gNB-DU 108-D is in charge of BW-related configuration, it informs higher layers whether this BWP is for SL BWP or UL BWP.

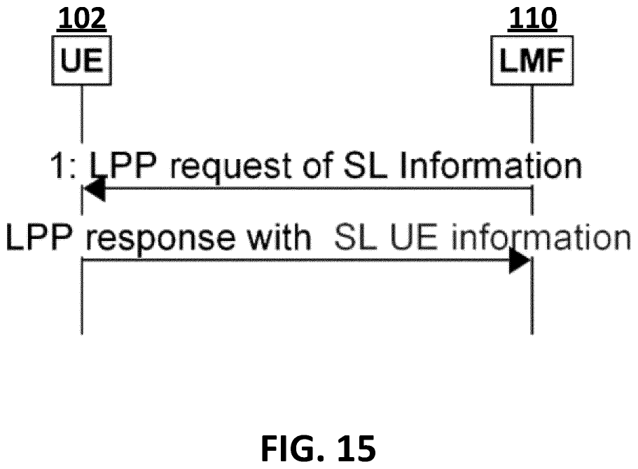

In another embodiment, the LMF 110 or positioning node (in the network or in a UE) can request the UE 102 directly via a positioning protocol (e.g., LPP, SLPP) to provide the UE SL Information via LPP request message as shown at step 1 in FIG. 15.

As response at step 2, the UE 102 provides the UE SL Information, e.g., comprising at least one of the SL BWP, SL BW capability, UE SL active BW configuration, BW configuration of SL resource pool, common RBs of SL resource pool, see other examples of SL-related BW information that will be described in detail below.

In some embodiments, methods at positioning node (in a UE or network node), radio network node, and UE for enabling SL positioning, based on SL-related BW information are provided.

From LMF 110 perspective, for one possible implementation:
1) Signal a request over NRPPA signalling to RAN 104 to report the SL BWP associated to a specific UE 102; and
2) Receive the SL BWP configuration and signal it to other neighbor gNBs (non-serving nodes) for the purpose of sidelink positioning in in-coverage scenario.

From gNB 108 perspective, for one possible implementation:
1) From gNB-CU 108-C perspective:
   a. Receive a request for reporting the SL BWP information to the LMF 110;
   b. Signalling the request for SL BWP to the gNB-DU 108-D;
   c. Signalling the SL BW to UE 102 via RRC for positioning purpose;
   d. Reporting the SL BWP information to the LMF 110; and
   e. Receiving the SL positioning configuration with the BWP when the CU is a non serving gNB-CU and signalling it to the gNB-DU 108-D.
2) From gNB-DU 108-D perspective:
   a. Receive a request for reporting the SL BWP information to the gNB-CU 108-C;
   b. Configuring the UE SL BWP and reporting the SL BWP associated to the SL UE;
   c. Reporting the SL BWP information to the gNB-CU 108-C; and
   d. Receiving the SL positioning configuration with the BWP when the DU is a non serving gNB-DU.

From UE 102's perspective, for one possible implementation:
1) Reports its SL BWP capability to the network nodes (gNB 108 and/or LMF 110); and
2) Receives the SL BWP configuration.

Certain embodiments may provide one or more of the following technical advantage(s). For example, with some embodiments of the present disclosure, it is possible to enable SL positioning session, based on the SL-related BW (e.g., SL Bandwidth Part (BWP)) information, which otherwise might not be possible.

The embodiments described herein are applicable for any type of D2D operation including SL, ProSe, V2X, operation via PC5 interface or both PC5 and Uu interface, etc.

Currently, the SL operation in NR is standardized for TDD frequency bands in frequency range 1 (FR1), e.g., NR band 38 or NR unlicensed band 47. However, the embodiments described herein are not limited to any specific frequency range or frequency band or duplex mode.

The terms “SL resource pool” and “SL PRS resource pool” can be used interchangeably, at least in some examples.

The term “positioning node” herein may refer to any physical or logical node or function capable of at least one of: calculating or estimating a location (e.g., based on positioning measurements), providing positioning assistance data, collecting, managing, and/or processing positioning measurements, receiving a location service request, providing a location service response, etc. In some examples, positioning node may be in a UE. In some examples, positioning node may be in a radio network node or in a core network. In other examples, positioning node is not comprised in a radio access network. Some examples of positioning node: LMF, E-SMLC, Gateway Mobile Location Center (GMLC), user-plane positioning node, Secure User Plane Location (SUPL), SUPL Location Platform (SLP), etc.

Examples of network nodes are NodeB, base station (BS), multi-standard radio (MSR) radio node such as MSR BS, eNodeB, gNodeB, MeNB, SeNB, location measurement unit (LMU), integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN, access point (AP), transmission points, transmission nodes, transmission reception point (TRP), RRU, RRH, RDS (Radio Dot System), nodes in distributed antenna system (DAS), core network node (e.g. MSC, MME etc.), O&M, OSS, SON, positioning node (e.g. E-SMLC, LMF, etc.), etc.

The non-limiting term “UE” refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, PDA, tablet, mobile terminals, smart phone, laptop embedded equipment (LEE), laptop mounted equipment (LME), USB dongles, etc.

The term “time resource” used herein may correspond to any type of physical resource or radio resource expressed in terms of length of time. Examples of time resources are: symbol, time slot, subframe, radio frame, Transmission Time Interval (TTI), interleaving time, slot, sub-slot, mini-slot, system frame number (SFN), hyper SFN (H-SFN), etc.

The term “SL reference signal (SL RS)” used in the embodiments refer to any type of RS which can be transmitted by a UE on a SL. Examples of such RS are SL PRS, SL SRS, SL-SSB/S-SSB, SLSS/S-SS, S-PSS, S-SSS, PSBCH or any combination e.g. S-SS/PSBCH (S-SS+S-PSS+PSBCH).

Herein, SL positioning reference signal or SL PRS can be used to denote any RS (including SL PRS, SL SRS, etc.) used for an SL positioning measurement.

### Embodiments

SL-related BW information (for SL positioning purpose) can comprise one or more of actual configuration, recommended configuration, preferred configuration, expected configuration parameters of UE bandwidth for SL positioning and/or other parameters or UE capability impacting the UE bandwidth for SL positioning. It can be the SL-related BW information provided for the first time or can be an update to a previously provided SL-related BW information. The SL-related BW information can be associated with an on-going SL positioning session or a future SL positioning session or a SL positioning session in a specific UE state or under specific conditions (e.g., during handover, under specific type of coverage, etc.).

Examples of the SL-related BW information for SL positioning purpose comprise at least one of:
SL positioning bandwidth-related configuration (e.g., for SL positioning transmission, reception, or measurement over PC5 interface for SL positioning purpose), e.g.:
   SL bandwidth configuration for SL positioning (e.g., start, center or other reference location in frequency, width in frequency in frequency units such as Hz, number of RBs, etc.).
   SL Bandwidth Part (BWP) configuration SL positioning (e.g., SL BWP list, number of all BWPs, the number of activated BWPs, one or more BWP configuration parameters, an indication of whether a BWP is activated or deactivated, number of resource blocks associated with an SL BWP, Sub-Carrier Spacing (SCS) associated with SL BWP, CP associated with SL BWP, a parameter indicative of SL BWP location in frequency, etc.).
   SCS configuration for SL positioning.
   Resource pool configuration associated with SL positioning BWP.
   SL positioning BW capability or SL positioning BWP capability.
   Number of SL positioning frequency layers which the UE can simultaneously support and operate.
   Indication of availability/non-availability or possibility/impossibility to use the SL positioning resources.
   A mismatch indication between SL-related BW configuration for SL positioning and Uu BW-related configuration.
Bandwidth-related configuration for other SL operation (e.g., SL transmission, SL reception, SL measurement, SL communication, SL sensing, or other non-positioning operation via PC5, etc.) which impacts the bandwidth-related configuration for SL positioning, e.g.:
   SL bandwidth configuration for SL communication, SL sensing, or non-positioning measurements via PC5 (e.g., start, center or other reference location in frequency, width in frequency in frequency units such as Hz, number of RBs, etc.).
   SL BWP configuration SL positioning (e.g., SL BWP list, number of all BWPs, the number of activated BWPs, one or more BWP configuration parameters, an indication of whether a BWP is activated or deactivated, number of resource blocks associated with an SL BWP, SCS associated with SL BWP, CP associated with SL BWP, a parameter indicative of SL BWP location in frequency, etc.).
   SL SCS configuration.
   Resource pool configuration associated with SL BWP.
   SL BW capability or SL BWP capability.
   Number of SL frequency layers which the UE can simultaneously support and operate.
   A mismatch indication between SL-related BW configuration and Uu BW-related configuration.
Bandwidth-related configuration for non-SL operation (e.g., transmission, reception, measurement, communication, sensing, or any other operation via Uu, etc.) which impacts the bandwidth-related configuration for SL positioning its availability for SL positioning, e.g.:
   UL BWP configuration/capability
   UL SCS or UL BWP SCS
   Number of Uu frequency layers which the UE can simultaneously support and operate.
   A mismatch indication between Uu BW-related configuration and SL-related BW configuration (general or for SL positioning).
Time resources or a pattern of time resources associated with any of the above SL-related BW information, i.e., during which resources it applies (e.g., a first SL BWP configuration for a first set of time resource, a second SL BWP configuration for a second set of time resources different from the first set of time resources, UL SCS for the next UL slot, etc.).

The SL-related BW information can be UE-specific or can be common for at least some UEs.

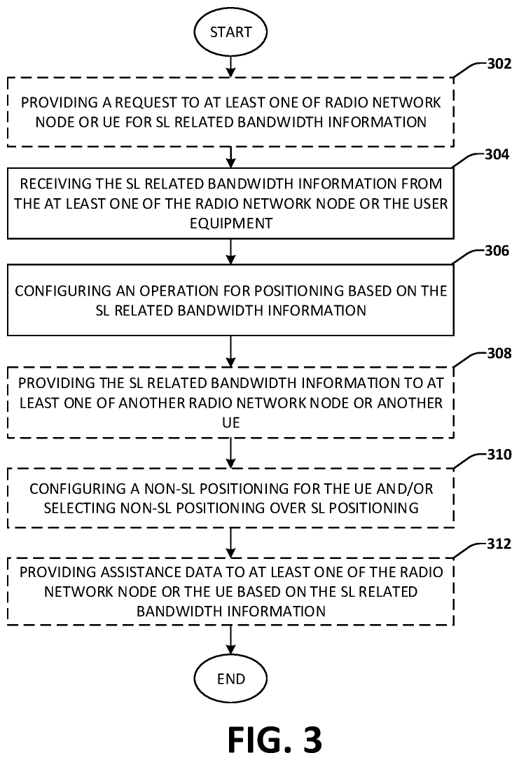

The embodiments described herein concern: Positioning node (e.g., LMF), Radio network node (e.g., gNB), and UE. It is to be appreciated that in FIGS. 3-7, steps in the flowcharts that are considered optional are marked with dashed lines.

FIG. 3 shows an example of a flow chart for a method performed by a positioning node for obtaining SL related bandwidth information in accordance with some embodiments of the present disclosure.

Methods in a positioning node (in UE or network):
Positioning node (e.g., in UE or network node) sends a request message at 302 to at least one of a radio network node (e.g., to gNB via NRPPA) or UE (e.g., via SLPP or LPP), to obtain SL-related BW information.
At step 304, the positioning node obtains or receives the SL-related BW information, e.g., from at least one of a radio network node or UE.
At step 306, the positioning node uses the obtained SL-related BW information for SL positioning or for an operation for positioning based on the SL related BW information.

According to this part of the disclosure, positioning node (e.g., in a UE or network node) obtains SL-related BW information, e.g., from at least one of a radio network node or UE, and uses it for SL positioning.

See the definition and some examples of a positioning node and examples for SL-related BW information.

In some examples, the positioning node may also send a request message and receive the SL-related BW information in response to the request message. An example radio network node is gNB and an example protocol for communication between the positioning node and the radio network node is NRPPa. An example protocol for communication between the positioning node and the UE is LPP or SL positioning protocol, SLPP.

In a further example, a request message to the radio network node can trigger a further action in the radio network node for acquiring the SL-related BW information, at least a part of it. To acquire the SL-related BW information, the radio network node may further request the necessary information from another node (e.g., another radio network node or UE).

The positioning node can use the SL-related BW information, e.g., for at least one of:
sending the obtained SL-related BW information to another node at step 308 (e.g., at least one of another UE or a radio network node such as a non-serving gNB) for the purpose of SL or non-SL positioning or to enable SL or non-SL positioning or to reduce performance degradation due to SL positioning,
configuring an operation (e.g., a transmission, reception, or measurement of a radio signal) for positioning in a radio network node or UE, based on the obtained SL-related BW information,
   in further example, the positioning node can receive a message from the radio network node/UE in response to the configuration message, e.g., an acknowledgement, a confirmation of successful configuration in the radio network node/UE, a failure message indicative of that the configuration was not successful or could not be performed.
configuring an operation for positioning in a UE, based on the obtained SL-related BW information,
configuring non-SL positioning at step 310 for UE, based on the SL-related BW information, and/or selecting non-SL positioning over SL positioning, based on the SL-related BW information (e.g., when SL positioning BWP is not available upon the need or uncertain)
providing assistance data at step 312 to at least one of a UE or radio network node, based on the BW-related information,
configuring or recommending to at least one of a UE or another radio network node (e.g., for configuring in the radio network node or in the UE by the radio network node) at least one parameter, based on SL-related BW information, e.g.:
   Time- and/or frequency resources or measurement gap configuration for performing at least one radio measurement (for SL positioning, RRM, etc.) or receiving a radio signal for (SL or non-SL) positioning,
      If the resources/gaps are for SL radio signals (e.g., to avoid/reduce interruptions in UE communication), then they can be configured to at least partly overlap with the SL resources or SL resource pool associated with the SL BWP,
      If the resources/gaps are for radio signals outside SL BWP, then they can be configured to minimize or avoid overlap with the SL resources or SL resource pool associated with the SL BWP;
   SCS for at least one transmission and/or reception of a radio signal,
   SCS for SL positioning measurements,
   SCS for UL BWP (e.g., so that UE UL BWP SCS matches with the SL BWP SCS),
   UE UL BWP (e.g., so that UE UL BWP matches with the SL BWP),
   Another example of using:
      positioning node determines whether Uu BW-related configuration and SL-related BW configuration (e.g., UL BWP and SL BWP or UL BWP SCS and SL BWP SCS) mismatch or not for a first UE (e.g., based on one or more of: message from the UE, message from a first gNB serving the first UE, pre-configured information, etc.) and in case of mismatch indicates to a radio network node (e.g., the first gNB or a second gNB) the mismatch and/or the need to change BW-related configuration for the first UE and/or a second UE involved in the same SL positioning session as the first UE, wherein the need for change may also comprise a recommended configuration setting to achieve the matching.
         Positioning node may compare at least one of the Uu BW-related configuration parameters and the corresponding SL-related BW configuration parameters and determine the mismatch when, e.g., the corresponding parameters are configured differently for Uu and SL, etc.),
         Positioning node may obtain the SL-related BW information (e.g., from a UE or a radio network node, or from internal configuration),
         Positioning node may obtain the UL BWP information associated with the first UE, e.g., from the first UE or its serving gNB,
         In response to the indication, the radio network node may further indicate to the positioning node whether the UE BW-related configuration has changed or will be changed for the UE to match with the SL-related BW configuration.

See also related methods described for UE and radio network node, respectively.

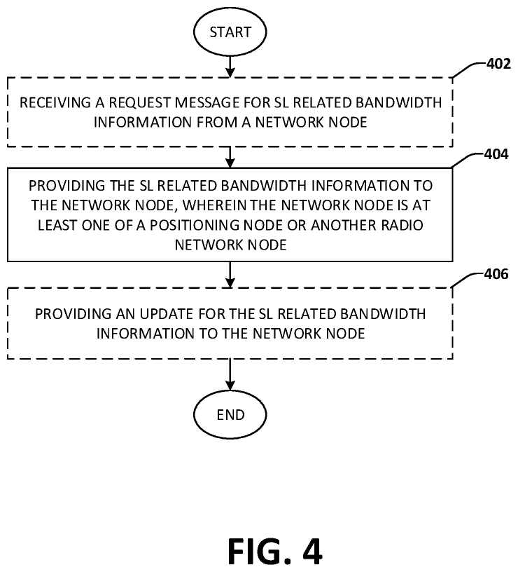

FIG. 4 shows an example of a flow chart for a method performed by a radio network node for providing SL related bandwidth information in accordance with some embodiments of the present disclosure.

### Methods in a Radio Network Node:

See also related embodiments described for positioning node and UE, respectively.

### Radio Network Node Providing SL-Related BW Information.

Radio network RN1 receives a request message at 402 for SL information from another network node (e.g., positioning node or another radio network node RN2).
Radio network node RN1 provides at step 404 SL-related BW information to another network node (e.g., positioning node and/or at least one another radio network node RN2).
Radio network node RN1 provides at step 406 an update for the SL-related BW information to another network node (e.g., positioning node and/or at least one another radio network node RN2).

Radio network node (RN1) can provide SL-related BW information to another network node, e.g., positioning node which may be a UE or network node (e.g., via positioning protocol, LPP, SL positioning protocol, SLPP, etc.) and/or at least one another radio network node RN2 (e.g., via Xn), for SL positioning purpose. The providing can be in an unsolicited way (e.g., upon a trigger, availability of an update, etc.) or in response to receiving a request message for SL information from another network node, e.g., positioning node or another radio network node RN2. See also related methods described for RN2.

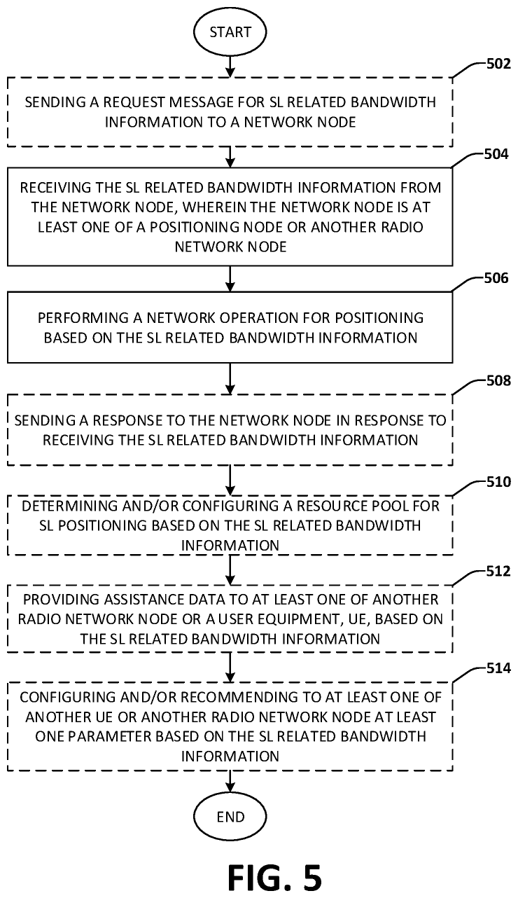

FIG. 5 shows an example of a flow chart for a method performed by a radio network node for positioning based on SL related bandwidth information in accordance with some embodiments of the present disclosure.
Radio network node RN2 sends a request message at step 502 for SL information to another network node (e.g., positioning node or another radio network node RN1).
Radio network node RN2 receives at step 504 SL-related BW information from another network node (e.g., positioning node or another radio network node RN1).
Using the received SL-related BW information for positioning or some network operation for positioning at step 506.
Sending a message at step 508 in response to the received SL-related BW information.

Radio network node RN2 (e.g., gNB) can receive SL-related BW information from another network node (e.g., positioning node or another radio network node RN1). In some examples, RN2 may receive the SL-related BW information in response to its request message. See also related methods described for RN1. RN2 can then use the received SL-related BW information for positioning, e.g.:
sending the obtained SL-related BW information to another network node (e.g., a neighbor gNB, non-serving gNB, positioning node, etc.) for the purpose of SL or non-SL positioning or to enable SL or non-SL positioning or to reduce performance degradation due to SL positioning,
configuring an operation (e.g., a transmission, reception, or measurement of a radio signal) for positioning in a radio network node or UE, based on the obtained SL-related BW information,
   in further example, the positioning node can receive a message from the radio network node/UE in response to the configuration message, e.g., an acknowledgement, a confirmation of successful configuration in the radio network node/UE, a failure message indicative of that the configuration was not successful or could not be performed.
determining and/or configuring a resource pool for SL positioning at step 510, based on the obtained SL-related BW information,
providing assistance data at step 512 to a UE or radio network node, based on the BW-related information,
configuring or recommending at step 514 to a UE or another radio network node at least one parameter, based on SL-related BW information, e.g.:
   Time- and/or frequency resources or measurement gap configuration for performing at least one radio measurement (for SL positioning, RRM, etc.) or receiving a radio signal for (SL or non-SL) positioning,
      If the resources/gaps are for SL radio signals (e.g., to avoid/reduce interruptions in UE communication), then they can be configured to at least partly overlap with the SL resources or SL resource pool associated with the SL BWP,
      If the resources/gaps are for radio signals outside SL BWP, then they can be configured to minimize or avoid overlap with the SL resources or SL resource pool associated with the SL BWP;
   SCS for at least one transmission and/or reception of a radio signal,
   SCS for SL positioning measurements,
   SCS for UL BWP (e.g., so that UE UL BWP SCS matches with the SL BWP SCS),
   UE UL BWP (e.g., so that UE UL BWP matches with the SL BWP),
   Another example of using:
      Radio network node obtains the information on whether Uu BW-related configuration and SL-related BW configuration match or do not match (e.g., match when a corresponding parameter has the same setting; examples: UL BWP and SL BWP or UL BWP SCS and SL BWP SCS) and if not, adapts the configuration of one of them (e.g., adapts Uu parameter to match with the SL parameter or vice versa); the radio network node may also indicate to another node (e.g., from which BW-related information was received) whether the adaption is possible, has been done, or will be done.
         Radio network node can obtain the match/mismatch information, based on a message from UE or another network node (e.g., positioning node or serving gNB of the UE) which can comprise any one or more of: SL-related BW information, Uu BW-related information, indication of whether there is match/mismatch, recommendation to change or indication of a need for change, etc.

See also related methods described for positioning node and UE, respectively.

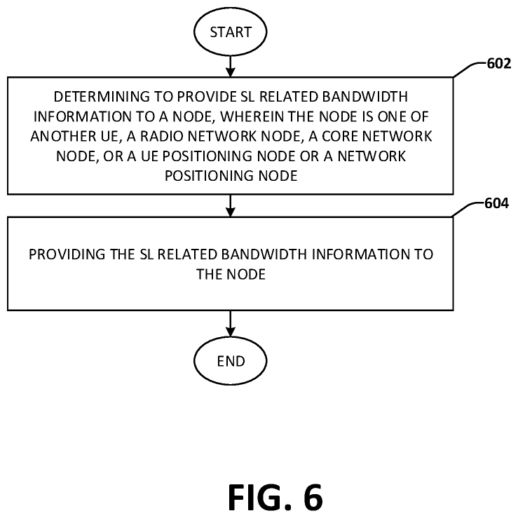

FIG. 6 shows an example of a flow chart for a method performed by a User Equipment (UE) for providing SL related bandwidth information in accordance with some embodiments of the present disclosure.

### Methods in a UE:

A first UE determines a need, at step 602, to provide the SL-related BW information or its update to another node (e.g., to at least one second UE, radio network node, positioning node in a UE, or positioning node in the network).
A first UE provides, at step 604, the SL-related BW information or its update to another node (e.g., to at least one second UE, radio network node, positioning node in a UE, or positioning node in the network) to enable SL positioning.

According to this part of the disclosure, UE determines a need to provide the SL-related BW information or its update to another node (e.g., to at least one second UE, radio network node, positioning node in a UE, or positioning node in the network) and provides the SL-related BW information or its update to the other node. The SL-related BW information is provided to enable SL positioning involving the first UE and/or assist another UE (a third UE, which may or may not be different from the second UE) in SL positioning (e.g., transmitting signals for SL positioning, receiving signals for SL positioning, performing an SL positioning measurement, etc.).

Determining the need can be based upon receiving a message from another node (e.g., a request message from at least one second UE, radio network node, positioning node in a UE, or positioning node in the network), a triggering condition, a timer, upon a cell change (e.g., handover), upon engaging into SL positioning operation, etc. A request message can be specifically for the SL-related BW information or can be for the SL information comprising at least SL-related BW information.

The BW-related information can be provided via L1, L2, and/or L3 signaling, via PC5 and/or Uu interfaces, directly or via other nodes (e.g., to a positioning node transparently via gNB, etc.). Some examples are: a positioning protocol (e.g., LPP or SL positioning protocol, SLPP), RRC, control channel, etc.

See also the related methods described for positioning node and radio network node, respectively.

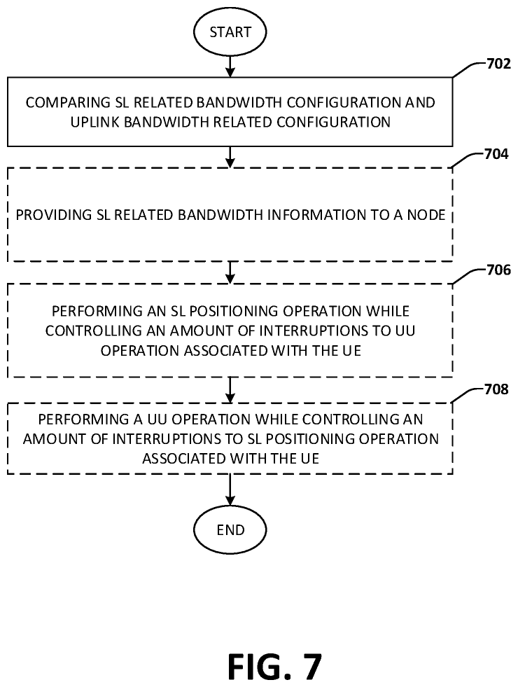

FIG. 7 shows an example of a flow chart for a method performed by a UE for controlling interruptions due to a mismatch between SL related bandwidth information and uplink bandwidth related information in accordance with some embodiments of the present disclosure.

Methods to control interruptions in the UE due to a mismatch between SL-related BW configuration and Uu BW-related configuration (e.g., between SL BWP and UL BWP configuration or SCS of the SL BWP and SCS of the UL BWP):
In an embodiment, a UE compares, at step 702, SL-related BW configuration and Uu BW-related configuration (e.g., SL BWP and UL BWP configuration or SCS of the SL BWP and SCS of the UL BWP). Based on the comparison, the UE may determine a mismatch (different configuration) between SL-related BW configuration and Uu BW-related configuration (e.g., different SL BWP and UL BWP configuration in at least one parameter or SCS of the SL BWP and SCS of the UL BWP). Upon determining a mismatch, the UE may do one, e.g., one or more of:
   At step 704, determine the need to provide the SL-related BW information or its update to another node (e.g., positioning node) and provide the SL-related BW information or its update to the other node, which may also comprise a mismatch indication between SL-related BW configuration (e.g., for SL positioning) and Uu BW-related configuration.
   At step 706, perform an SL positioning operation (e.g., SL positioning measurement), while controlling the amount of interruption to the UE operation via Uu interface (e.g., up to X symbols or slots). The controlling may comprise, e.g., determining the actual amount, determining an allowed or maximum amount, ensuring that an allowed amount is not exceeded e.g. by performing the SL positioning operation adaptively to or within the limit, indicating the actual, expected or allowed amount of interruption to another node, requesting reconfiguration of SL-related BW configuration to avoid/reduce the amount of interruption to SL positioning, indicating the mismatch or requesting reconfiguration when the amount of interruption exceeds a threshold, reporting a result of Uu operation while indicating Uu operation interruption occurrence and/or amount, reporting an error to the Uu operation upon interruption occurrence or when the amount of interruption exceeds a threshold (which may further comprise indication of the error source), etc.
      The amount of interruption can be pre-defined, configured by a radio network node or positioning node (positioning node in network or positioning node in UE), or can be determined by the UE based on a pre-defined rule. The amount of interruption can depend, e.g., on the SL positioning measurement configuration, SL positioning measurement performance requirement, Uu operation configuration, DRX, SL DRX, etc.
      The amount of interruption determined by the UE may also be signaled to another node (e.g., another SL UE in the same SL positioning session, radio network node such as serving gNB, or positioning node).
   At step 708, perform an operation via Uu interface (e.g., Uu positioning measurement, reception or transmission via Uu interface, etc.), while controlling the amount of interruption to the UE SL positioning operation via SL interface (e.g., up to X symbols or slots). The controlling may comprise, e.g., determining the actual amount, determining an allowed or maximum amount, ensuring that an allowed amount is not exceeded e.g. by performing the operation via Uu interface adaptively to or within the limit, indicating the actual, expected or allowed amount of interruption to another node, requesting reconfiguration of SL-related BW configuration to avoid/reduce the amount of interruption to SL positioning, indicating the mismatch or requesting reconfiguration when the amount of interruption exceeds a threshold, reporting a result of SL positioning while indicating SL positioning operation interruption occurrence and/or amount, reporting an error to the SL positioning operation upon interruption occurrence or when the amount of interruption exceeds a threshold (which may further comprise indication of the error source), etc.
      The amount of interruption can be pre-defined, configured by a radio network node or positioning node (positioning node in network or positioning node in UE), or can be determined by the UE based on a pre-defined rule. The amount of interruption can depend, e.g., on the SL positioning measurement configuration, SL positioning measurement performance requirement, Uu operation configuration, DRX, SL DRX, etc.
      The amount of interruption determined by the UE may also be signaled to another node (e.g., another SL UE in the same SL positioning session, radio network node such as serving gNB, or positioning node).

### NRPPA Embodiments

In one embodiment, LMF can send a query or request message to a radio network node (e.g., gNB) with a new indication to signal the SL-related BW information for one or more UEs using NRPPA signalling. The signalling can be UE associated or can be common for a plurality of UEs. In one example embodiment, the new indication to query of the SL UE BW information may be included as part of POSITIONING INFORMATION REQUEST message defined in 3GPP TS 38.455.

Upon receiving the query message from the LMF with a request for UE SL-related BW information, the gNB-CU configures the UE for SL positioning transmission and transmits the SL configuration associated with the UE to the LMF. In one example embodiment, the new SL UE BW-related information may be a part of the POSITIONING INFORMATION RESPONSE message defined in 3GPP TS 38.455.

In case of update of the SL UE BW-related information, the gNB-CU sends an update message to LMF via NRPPA signaling. In one example embodiment, the new indication containing the update of the SL UE BW information may be included as part of POSITIONING INFORMATION UPDATE message defined in 3GPP TS 38.455.

In one embodiment, the LMF sends the received SL information received from the serving gNB to non-serving nodes for the purpose of positioning.

In one embodiment, the SL-related BW information contains, e.g., any of: SL BWP configuration, SL UE active BW configuration, BW configuration of SL resource pool, common RBs of SL resource pool, SCS, indicator if this is UL BW or SL BW, see other examples of SL-related BW information above.

In one embodiment, the gNB-CU can send a failure message to LMF in case the SL-related BW configuration could not be performed.

### F1AP Embodiments

In one embodiment, upon receiving the query message from LMF with a request for reporting the UE SL-related BW information, the gNB-CU sends the F1AP equivalent query message to gNB-DU to request configuring the UE with SL-related BW information. The F1AP equivalent query message may be, in one example embodiment, the F1AP POSITIONING INFORMATION REQUEST message defined in TS 38.473.

In one embodiment, the gNB-DU upon receiving the request from the gNB-DU via F1AP message with the query for SL UE BW information, configures the UE with SL BWPs and signals the configured SL information to the gNB-CU via F1AP signalling. The F1AP response message may be, in one example embodiment, the F1AP POSITIONING INFORMATION RESPONSE message defined in TS 38.473.

In case of update of the SL UE BWP Information, the gNB-DU sends an update message to gNB-CU via F1 signalling. In one example embodiment, the new indication containing the update of the SL UE BW information may be included as part of F1AP POSITIONING INFORMATION UPDATE message defined in 3GPP TS 38.473.

In one embodiment, the SL information contains the UE SL BWP configuration, SL UE active BW configuration, BW configuration of SL resource pool, common RBs of SL resource pool, SCS, and indicator if this is UL BW or SL BW.

In one embodiment, the gNB-DU can send a failure message to gNB-CU in case the SL-BWP configuration could not be performed.

### XnAP Embodiments

In one embodiment, the gNB-CU can send the SL-related BW information to other gNB-CUs connected over the Xn interface during e.g., mobility and dual connectivity procedures, including cell change, handover, etc.

### RRC Embodiments

In one embodiment, the network (e.g., gNB-CU) configures the UE via RRC with a SL UE BW-related configuration to enable SL positioning.

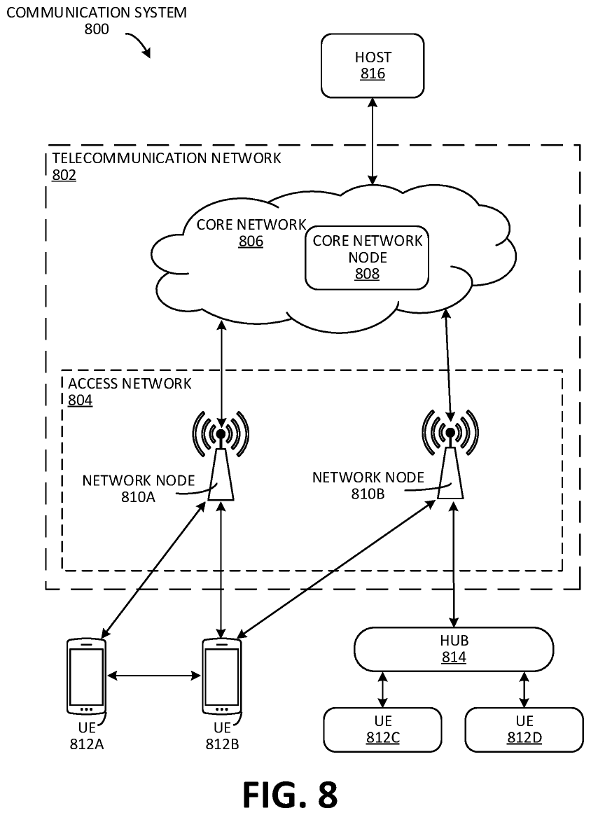

FIG. 8 shows an example of a communication system 800 in accordance with some embodiments.

In the example, the communication system 800 includes a telecommunication network 802 that includes an access network 804, such as a Radio Access Network (RAN), and a core network 806, which includes one or more core network nodes 808. The access network 804 includes one or more access network nodes, such as network nodes 810A and 810B (one or more of which may be generally referred to as network nodes 810), or any other similar Third Generation Partnership Project (3GPP) access nodes or non-3GPP Access Points (APs). Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 802 includes one or more Open-RAN (ORAN) network nodes. An ORAN network node is a node in the telecommunication network 802 that supports an ORAN specification (e.g., a specification published by the O-RAN Alliance, or any similar organization) and may operate alone or together with other nodes to implement one or more functionalities of any node in the telecommunication network 802, including one or more network nodes 810 and/or core network nodes 808.

Examples of an ORAN network node include an Open Radio Unit (O-RU), an Open Distributed Unit (O-DU), an Open Central Unit (O-CU), including an O-CU Control Plane (O-CU-CP) or an O-CU User Plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 810 facilitate direct or indirect connection of User Equipment (UE), such as by connecting UEs 812A, 812B, 812C, and 812D (one or more of which may be generally referred to as UEs 812) to the core network 806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 800 may include any number of wired or wireless networks, network nodes, UEs, and/or any other components or systems that may facilitate or participate in the communication of data and/or signals whether via wired or wireless connections. The communication system 800 may include and/or interface with any type of communication, telecommunication, data, cellular, radio network, and/or other similar type of system.

The UEs 812 may be any of a wide variety of communication devices, including wireless devices arranged, configured, and/or operable to communicate wirelessly with the network nodes 810 and other communication devices. Similarly, the network nodes 810 are arranged, capable, configured, and/or operable to communicate directly or indirectly with the UEs 812 and/or with other network nodes or equipment in the telecommunication network 802 to enable and/or provide network access, such as wireless network access, and/or to perform other functions, such as administration in the telecommunication network 802.

In the depicted example, the core network 806 connects the network nodes 810 to one or more hosts, such as host 816. These connections may be direct or indirect via one or more intermediary networks or devices. In other examples, network nodes may be directly coupled to hosts. The core network 806 includes one more core network nodes (e.g., core network node 808) that are structured with hardware and software components. Features of these components may be substantially similar to those described with respect to the UEs, network nodes, and/or hosts, such that the descriptions thereof are generally applicable to the corresponding components of the core network node 808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 816 may be under the ownership or control of a service provider other than an operator or provider of the access network 804 and/or the telecommunication network 802, and may be operated by the service provider or on behalf of the service provider. The host 816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 800 of FIG. 8 enables connectivity between the UEs, network nodes, and hosts. In that sense, the communication system 800 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 802 is a cellular network that implements 3GPP standardized features. Accordingly, the telecommunication network 802 may support network slicing to provide different logical networks to different devices that are connected to the telecommunication network 802. For example, the telecommunication network 802 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 812 are configured to transmit and/or receive information without direct human interaction. For instance, a UE may be designed to transmit information to the access network 804 on a predetermined schedule, when triggered by an internal or external event, or in response to requests from the access network 804. Additionally, a UE may be configured for operating in single- or multi-Radio Access Technology (RAT) or multi-standard mode. For example, a UE may operate with any one or combination of WiFi, New Radio (NR), and LTE, i.e., being configured for Multi-Radio Dual Connectivity (MR-DC), such as Evolved UMTS Terrestrial RAN (E-UTRAN) NR-Dual Connectivity (EN-DC).

In the example, a hub 814 communicates with the access network 804 to facilitate indirect communication between one or more UEs (e.g., UE 812C and/or 812D) and network nodes (e.g., network node 810B). In some examples, the hub 814 may be a controller, router, content source and analytics, or any of the other communication devices described herein regarding UEs. For example, the hub 814 may be a broadband router enabling access to the core network 806 for the UEs. As another example, the hub 814 may be a controller that sends commands or instructions to one or more actuators in the UEs. Commands or instructions may be received from the UEs, network nodes 810, or by executable code, script, process, or other instructions in the hub 814. As another example, the hub 814 may be a data collector that acts as temporary storage for UE data and, in some embodiments, may perform analysis or other processing of the data. As another example, the hub 814 may be a content source. For example, for a UE that is a Virtual Reality (VR) headset, display, loudspeaker or other media delivery device, the hub 814 may retrieve VR assets, video, audio, or other media or data related to sensory information via a network node, which the hub 814 then provides to the UE either directly, after performing local processing, and/or after adding additional local content. In still another example, the hub 814 acts as a proxy server or orchestrator for the UEs, in particular if one or more of the UEs are low energy IoT devices.

The hub 814 may have a constant/persistent or intermittent connection to the network node 810B. The hub 814 may also allow for a different communication scheme and/or schedule between the hub 814 and UEs (e.g., UE 812C and/or 812D), and between the hub 814 and the core network 806. In other examples, the hub 814 is connected to the core network 806 and/or one or more UEs via a wired connection. Moreover, the hub 814 may be configured to connect to a Machine-to-Machine (M2M) service provider over the access network 804 and/or to another UE over a direct connection. In some scenarios, UEs may establish a wireless connection with the network nodes 810 while still connected via the hub 814 via a wired or wireless connection. In some embodiments, the hub 814 may be a dedicated hub—that is, a hub whose primary function is to route communications to/from the UEs from/to the network node 810B. In other embodiments, the hub 814 may be a non-dedicated hub—that is, a device which is capable of operating to route communications between the UEs and the network node 810B, but which is additionally capable of operating as a communication start and/or end point for certain data channels.

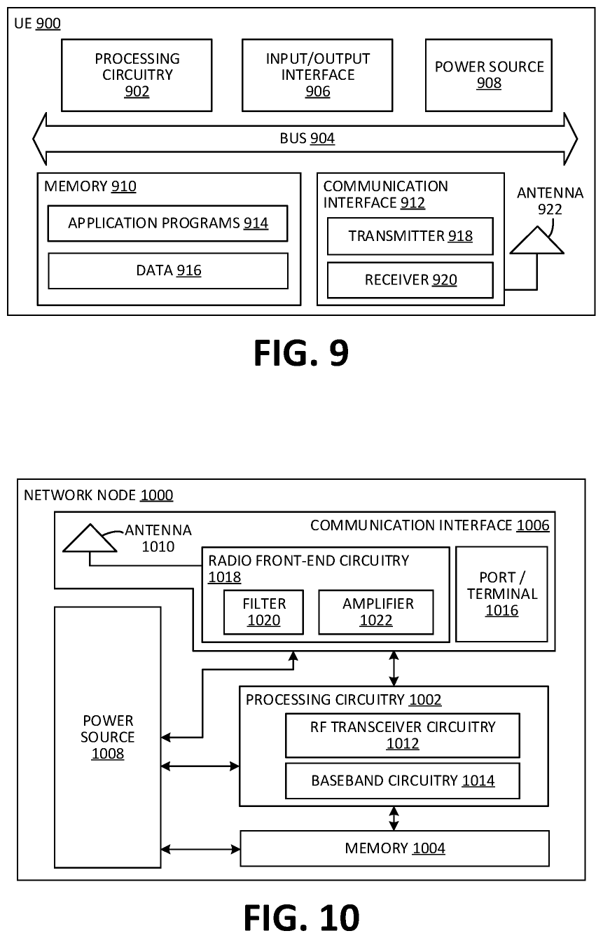

FIG. 9 shows a UE 900 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VOIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle, vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 900 includes processing circuitry 902 that is operatively coupled via a bus 904 to an input/output interface 906, a power source 908, memory 910, a communication interface 912, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry 902 is configured to process instructions and data and may be configured to implement any sequential state machine operative to execute instructions stored as machine-readable computer programs in the memory 910. The processing circuitry 902 may be implemented as one or more hardware-implemented state machines (e.g., in discrete logic, Field Programmable Gate Arrays (FPGAS), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 902 may include multiple Central Processing Units (CPUs).

In the example, the input/output interface 906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 908 is structured as a battery or battery pack. Other types of power sources, such as an external power source (e.g., an electricity outlet), photovoltaic device, or power cell, may be used. The power source 908 may further include power circuitry for delivering power from the power source 908 itself, and/or an external power source, to the various parts of the UE 900 via input circuitry or an interface such as an electrical power cable. Delivering power may be, for example, for charging of the power source 908. Power circuitry may perform any formatting, converting, or other modification to the power from the power source 908 to make the power suitable for the respective components of the UE 900 to which power is supplied.

The memory 910 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 910 includes one or more application programs 914, such as an operating system, web browser application, a widget, gadget engine, or other application, and corresponding data 916. The memory 910 may store, for use by the UE 900, any of a variety of various operating systems or combinations of operating systems.

The memory 910 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 910 may allow the UE 900 to access instructions, application programs, and the like stored on transitory or non-transitory memory media, to off-load data, or to upload data. An article of manufacture, such as one utilizing a communication system, may be tangibly embodied as or in the memory 910, which may be or comprise a device-readable storage medium.

The processing circuitry 902 may be configured to communicate with an access network or other network using the communication interface 912. The communication interface 912 may comprise one or more communication subsystems and may include or be communicatively coupled to an antenna 922. The communication interface 912 may include one or more transceivers used to communicate, such as by communicating with one or more remote transceivers of another device capable of wireless communication (e.g., another UE or a network node in an access network). Each transceiver may include a transmitter 918 and/or a receiver 920 appropriate to provide network communications (e.g., optical, electrical, frequency allocations, and so forth). Moreover, the transmitter 918 and receiver 920 may be coupled to one or more antennas (e.g., the antenna 922) and may share circuit components, software, or firmware, or alternatively be implemented separately.

In the illustrated embodiment, communication functions of the communication interface 912 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 912, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 900 shown in FIG. 9.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 10 shows a network node 1000 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), NR Node Bs (gNBs)), and O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node), and/or Remote Radio Units (RRUs), sometimes referred to as Remote Radio Heads (RRHs). Such RRUs may or may not be integrated with an antenna as an antenna integrated radio. Parts of a distributed radio base station may also be referred to as nodes in a Distributed Antenna System (DAS).

Other examples of network nodes include multiple Transmission Point (multi-TRP) 5G access nodes, Multi-Standard Radio (MSR) equipment such as MSR BSS, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1000 includes processing circuitry 1002, memory 1004, a communication interface 1006, and a power source 1008. The network node 1000 may be composed of multiple physically separate components (e.g., a NodeB component and an RNC component, or a BTS component and a BSC component, etc.), which may each have their own respective components. In certain scenarios in which the network node 1000 comprises multiple separate components (e.g., BTS and BSC components), one or more of the separate components may be shared among several network nodes. For example, a single RNC may control multiple NodeBs. In such a scenario, each unique NodeB and RNC pair may in some instances be considered a single separate network node. In some embodiments, the network node 1000 may be configured to support multiple RATs. In such embodiments, some components may be duplicated (e.g., separate memory 1004 for different RATs) and some components may be reused (e.g., a same antenna 1010 may be shared by different RATs). The network node 1000 may also include multiple sets of the various illustrated components for different wireless technologies integrated into network node 1000, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 1000.

The processing circuitry 1002 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 1000 components, such as the memory 1004, to provide network node 1000 functionality.

In some embodiments, the processing circuitry 1002 includes a System on a Chip (SOC). In some embodiments, the processing circuitry 1002 includes one or more of Radio Frequency (RF) transceiver circuitry 1012 and baseband processing circuitry 1014. In some embodiments, the RF transceiver circuitry 1012 and the baseband processing circuitry 1014 may be on separate chips (or sets of chips), boards, or units, such as radio units and digital units. In alternative embodiments, part or all of the RF transceiver circuitry 1012 and the baseband processing circuitry 1014 may be on the same chip or set of chips, boards, or units.

The memory 1004 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 1002. The memory 1004 may store any suitable instructions, data, or information, including a computer program, software, an application including one or more of logic, rules, code, tables, and/or other instructions capable of being executed by the processing circuitry 1002 and utilized by the network node 1000. The memory 1004 may be used to store any calculations made by the processing circuitry 1002 and/or any data received via the communication interface 1006. In some embodiments, the processing circuitry 1002 and the memory 1004 are integrated.

The communication interface 1006 is used in wired or wireless communication of signaling and/or data between a network node, access network, and/or UE. As illustrated, the communication interface 1006 comprises port(s)/terminal(s) 1016 to send and receive data, for example to and from a network over a wired connection. The communication interface 1006 also includes radio front-end circuitry 1018 that may be coupled to, or in certain embodiments a part of, the antenna 1010. The radio front-end circuitry 1018 comprises filters 1020 and amplifiers 1022. The radio front-end circuitry 1018 may be connected to the antenna 1010 and the processing circuitry 1002. The radio front-end circuitry 1018 may be configured to condition signals communicated between the antenna 1010 and the processing circuitry 1002. The radio front-end circuitry 1018 may receive digital data that is to be sent out to other network nodes or UEs via a wireless connection. The radio front-end circuitry 1018 may convert the digital data into a radio signal having the appropriate channel and bandwidth parameters using a combination of the filters 1020 and/or the amplifiers 1022. The radio signal may then be transmitted via the antenna 1010. Similarly, when receiving data, the antenna 1010 may collect radio signals which are then converted into digital data by the radio front-end circuitry 1018. The digital data may be passed to the processing circuitry 1002. In other embodiments, the communication interface 1006 may comprise different components and/or different combinations of components.

In certain alternative embodiments, the network node 1000 does not include separate radio front-end circuitry 1018; instead, the processing circuitry 1002 includes radio front-end circuitry and is connected to the antenna 1010. Similarly, in some embodiments, all or some of the RF transceiver circuitry 1012 is part of the communication interface 1006. In still other embodiments, the communication interface 1006 includes the one or more ports or terminals 1016, the radio front-end circuitry 1018, and the RF transceiver circuitry 1012 as part of a radio unit (not shown), and the communication interface 1006 communicates with the baseband processing circuitry 1014, which is part of a digital unit (not shown).

The antenna 1010 may include one or more antennas, or antenna arrays, configured to send and/or receive wireless signals. The antenna 1010 may be coupled to the radio front-end circuitry 1018 and may be any type of antenna capable of transmitting and receiving data and/or signals wirelessly. In certain embodiments, the antenna 1010 is separate from the network node 1000 and connectable to the network node 1000 through an interface or port.

The antenna 1010, the communication interface 1006, and/or the processing circuitry 1002 may be configured to perform any receiving operations and/or certain obtaining operations described herein as being performed by the network node 1000. Any information, data, and/or signals may be received from a UE, another network node, and/or any other network equipment. Similarly, the antenna 1010, the communication interface 1006, and/or the processing circuitry 1002 may be configured to perform any transmitting operations described herein as being performed by the network node 1000. Any information, data, and/or signals may be transmitted to a UE, another network node, and/or any other network equipment.

The power source 1008 provides power to the various components of the network node 1000 in a form suitable for the respective components (e.g., at a voltage and current level needed for each respective component). The power source 1008 may further comprise, or be coupled to, power management circuitry to supply the components of the network node 1000 with power for performing the functionality described herein. For example, the network node 1000 may be connectable to an external power source (e.g., the power grid or an electricity outlet) via input circuitry or an interface such as an electrical cable, whereby the external power source supplies power to power circuitry of the power source 1008. As a further example, the power source 1008 may comprise a source of power in the form of a battery or battery pack which is connected to, or integrated in, power circuitry. The battery may provide backup power should the external power source fail.

Embodiments of the network node 1000 may include additional components beyond those shown in FIG. 10 for providing certain aspects of the network node's functionality, including any of the functionality described herein and/or any functionality necessary to support the subject matter described herein. For example, the network node 1000 may include user interface equipment to allow input of information into the network node 1000 and to allow output of information from the network node 1000. This may allow a user to perform diagnostic, maintenance, repair, and other administrative functions for the network node 1000.

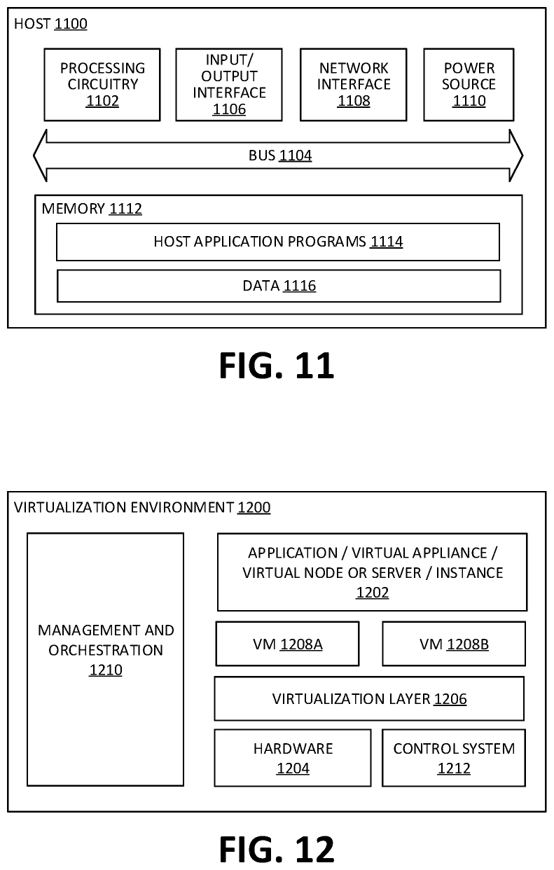

FIG. 11 is a block diagram of a host 1100, which may be an embodiment of the host 816 of FIG. 8, in accordance with various aspects described herein. As used herein, the host 1100 may be or comprise various combinations of hardware and/or software including a standalone server, a blade server, a cloud-implemented server, a distributed server, a virtual machine, container, or processing resources in a server farm. The host 1100 may provide one or more services to one or more UEs.

The host 1100 includes processing circuitry 1102 that is operatively coupled via a bus 1104 to an input/output interface 1106, a network interface 1108, a power source 1110, and memory 1112. Other components may be included in other embodiments. Features of these components may be substantially similar to those described with respect to the devices of previous figures, such as FIGS. 9 and 10, such that the descriptions thereof are generally applicable to the corresponding components of the host 1100.

The memory 1112 may include one or more computer programs including one or more host application programs 1114 and data 1116, which may include user data, e.g. data generated by a UE for the host 1100 or data generated by the host 1100 for a UE. Embodiments of the host 1100 may utilize only a subset or all of the components shown. The host application programs 1114 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 1114 may also provide for user authentication and licensing checks and may periodically report health, routes, and content availability to a central node, such as a device in or on the edge of a core network. Accordingly, the host 1100 may select and/or indicate a different host for Over-The-Top (OTT) services for a UE. The host application programs 1114 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 12 is a block diagram illustrating a virtualization environment 1200 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 1200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1200 includes components defined by the O-RAN Alliance, such as an O-Cloud environment orchestrated by a Service Management and Orchestration Framework via an O-2 interface.

Applications 1202 (which may alternatively be called software instances, virtual appliances, network functions, virtual nodes, virtual network functions, etc.) are run in the virtualization environment 1200 to implement some of the features, functions, and/or benefits of some of the embodiments disclosed herein.

Hardware 1204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1206 (also referred to as hypervisors or VM Monitors (VMMs)), provide VMs 1208A and 1208B (one or more of which may be generally referred to as VMs 1208), and/or perform any of the functions, features, and/or benefits described in relation with some embodiments described herein. The virtualization layer 1206 may present a virtual operating platform that appears like networking hardware to the VMs 1208.

The VMs 1208 comprise virtual processing, virtual memory, virtual networking, or interface and virtual storage, and may be run by a corresponding virtualization layer 1206. Different embodiments of the instance of a virtual appliance 1202 may be implemented on one or more of the VMs 1208, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 1208 may be a software implementation of a physical machine that runs programs as if they were executing on a physical, non-virtualized machine. Each of the VMs 1208, and that part of the hardware 1204 that executes that VM, be it hardware dedicated to that VM and/or hardware shared by that VM with others of the VMs 1208, forms separate virtual network elements. Still in the context of NFV, a virtual network function is responsible for handling specific network functions that run in one or more VMs 1208 on top of the hardware 1204 and corresponds to the application 1202.

The hardware 1204 may be implemented in a standalone network node with generic or specific components. The hardware 1204 may implement some functions via virtualization. Alternatively, the hardware 1204 may be part of a larger cluster of hardware (e.g., such as in a data center or CPE) where many hardware nodes work together and are managed via management and orchestration 1210, which, among others, oversees lifecycle management of the applications 1202. In some embodiments, the hardware 1204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a base station. In some embodiments, some signaling can be provided with the use of a control system 1212 which may alternatively be used for communication between hardware nodes and radio units.

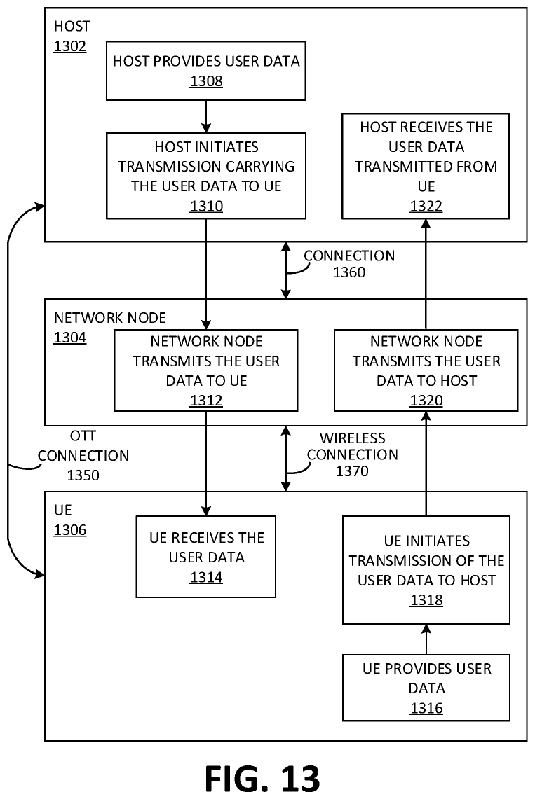

FIG. 13 shows a communication diagram of a host 1302 communicating via a network node 1304 with a UE 1306 over a partially wireless connection in accordance with some embodiments. Example implementations, in accordance with various embodiments, of the UE (such as the UE 812A of FIG. 8 and/or the UE 900 of FIG. 9), the network node (such as the network node 810A of FIG. 8 and/or the network node 1000 of FIG. 10), and the host (such as the host 816 of FIG. 8 and/or the host 1100 of FIG. 11) discussed in the preceding paragraphs will now be described with reference to FIG. 13.

Like the host 1100, embodiments of the host 1302 include hardware, such as a communication interface, processing circuitry, and memory. The host 1302 also includes software, which is stored in or is accessible by the host 1302 and executable by the processing circuitry. The software includes a host application that may be operable to provide a service to a remote user, such as the UE 1306 connecting via an OTT connection 1350 extending between the UE 1306 and the host 1302. In providing the service to the remote user, a host application may provide user data which is transmitted using the OTT connection 1350.

The network node 1304 includes hardware enabling it to communicate with the host 1302 and the UE 1306. The connection 1360 may be direct or pass through a core network (like the core network 806 of FIG. 8) and/or one or more other intermediate networks, such as one or more public, private, or hosted networks. For example, an intermediate network may be a backbone network or the Internet.

The UE 1306 includes hardware and software, which is stored in or accessible by the UE 1306 and executable by the UE's processing circuitry. The software includes a client application, such as a web browser or operator-specific “app” that may be operable to provide a service to a human or non-human user via the UE 1306 with the support of the host 1302. In the host 1302, an executing host application may communicate with the executing client application via the OTT connection 1350 terminating at the UE 1306 and the host 1302. In providing the service to the user, the UE's client application may receive request data from the host's host application and provide user data in response to the request data. The OTT connection 1350 may transfer both the request data and the user data. The UE's client application may interact with the user to generate the user data that it provides to the host application through the OTT connection 1350.

The OTT connection 1350 may extend via the connection 1360 between the host 1302 and the network node 1304 and via a wireless connection 1370 between the network node 1304 and the UE 1306 to provide the connection between the host 1302 and the UE 1306. The connection 1360 and the wireless connection 1370, over which the OTT connection 1350 may be provided, have been drawn abstractly to illustrate the communication between the host 1302 and the UE 1306 via the network node 1304, without explicit reference to any intermediary devices and the precise routing of messages via these devices.

As an example of transmitting data via the OTT connection 1350, in step 1308, the host 1302 provides user data, which may be performed by executing a host application. In some embodiments, the user data is associated with a particular human user interacting with the UE 1306. In other embodiments, the user data is associated with a UE 1306 that shares data with the host 1302 without explicit human interaction. In step 1310, the host 1302 initiates a transmission carrying the user data towards the UE 1306. The host 1302 may initiate the transmission responsive to a request transmitted by the UE 1306. The request may be caused by human interaction with the UE 1306 or by operation of the client application executing on the UE 1306. The transmission may pass via the network node 1304 in accordance with the teachings of the embodiments described throughout this disclosure. Accordingly, in step 1312, the network node 1304 transmits to the UE 1306 the user data that was carried in the transmission that the host 1302 initiated, in accordance with the teachings of the embodiments described throughout this disclosure. In step 1314, the UE 1306 receives the user data carried in the transmission, which may be performed by a client application executed on the UE 1306 associated with the host application executed by the host 1302.

In some examples, the UE 1306 executes a client application which provides user data to the host 1302. The user data may be provided in reaction or response to the data received from the host 1302. Accordingly, in step 1316, the UE 1306 may provide user data, which may be performed by executing the client application. In providing the user data, the client application may further consider user input received from the user via an input/output interface of the UE 1306. Regardless of the specific manner in which the user data was provided, the UE 1306 initiates, in step 1318, transmission of the user data towards the host 1302 via the network node 1304. In step 1320, in accordance with the teachings of the embodiments described throughout this disclosure, the network node 1304 receives user data from the UE 1306 and initiates transmission of the received user data towards the host 1302. In step 1322, the host 1302 receives the user data carried in the transmission initiated by the UE 1306.

In an example scenario, factory status information may be collected and analyzed by the host 1302. As another example, the host 1302 may process audio and video data which may have been retrieved from a UE for use in creating maps. As another example, the host 1302 may collect and analyze real-time data to assist in controlling vehicle congestion (e.g., controlling traffic lights). As another example, the host 1302 may store surveillance video uploaded by a UE. As another example, the host 1302 may store or control access to media content such as video, audio, VR, or AR which it can broadcast, multicast, or unicast to UEs. As other examples, the host 1302 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 1350 between the host 1302 and the UE 1306 in response to variations in the measurement results. The measurement procedure and/or the network functionality for reconfiguring the OTT connection 1350 may be implemented in software and hardware of the host 1302 and/or the UE 1306. In some embodiments, sensors (not shown) may be deployed in or in association with other devices through which the OTT connection 1350 passes; the sensors may participate in the measurement procedure by supplying values of the monitored quantities exemplified above, or by supplying values of other physical quantities from which software may compute or estimate the monitored quantities. The reconfiguring of the OTT connection 1350 may include message format, retransmission settings, preferred routing, etc.; the reconfiguring need not directly alter the operation of the network node 1304. Such procedures and functionalities may be known and practiced in the art. In certain embodiments, measurements may involve proprietary UE signaling that facilitates measurements of throughput, propagation times, latency, and the like by the host 1302. The measurements may be implemented in that software causes messages to be transmitted, in particular empty or ‘dummy’ messages, using the OTT connection 1350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

Those skilled in the art will recognize improvements and modifications to the embodiments of the present disclosure. All such improvements and modifications are considered within the scope of the concepts disclosed herein.

### REFERENCES

1. TS 38.455 NRPPA v 17.4.0 https://www.3gpp.org/ftp/Specs/archive/38_series/38.455/38455-h40.zip
2. TS 38.473 F1AP v 17.4.1 https://www.3gpp.org/ftp/Specs/archive/38_series/38.473/38473-h41.zip

1. A method performed by a positioning node for obtaining sidelink, SL, related bandwidth information, the method comprising:
receiving SL related bandwidth information from at least one of a radio network node or a User Equipment, UE; and
configuring an operation for positioning based on the SL related bandwidth information.

2. The method of claim 1, wherein the receiving the SL related bandwidth information is in response to:
providing a request to the at least one of the radio network node or the UE for the SL related bandwidth information.

3. The method of claim 1, further comprising:
providing the SL related bandwidth information to at least one of another radio network node or another UE.

4. The method of claim 1, wherein the configuring the operation for positioning comprises configuring the operation in at least one of the radio network node or the UE.

5. The method of claim 3, wherein the configuring the operation for positioning comprises configuring the operation in at least one of the other radio network node or the other UE.

6. The method of any of claim 1, further comprising at least one of:
configuring a non-SL positioning for the UE; and
selecting non-SL positioning over SL positioning.

7. The method of claim 1, further comprising:
providing assistance data to at least one of the radio network node or the UE based on the SL related bandwidth information.

8. The method of any of claim 1, further comprising at least one of:
configuring at least one of another UE or another radio network node with at least one parameter based on the SL related bandwidth information; and
recommending, to at least one of another UE or another radio network node, at least one parameter based on the SL related bandwidth information.

9. The method of claim 1, wherein the positioning node is one of a UE or a core network node.

10. The method of claim 1, wherein the operation is at least one of:
a transmission;
a reception; and
a measurement of a radio signal.

11. The method of claim 1, wherein the SL related bandwidth information comprises at least one of:
SL positioning bandwidth-related configuration;
bandwidth related configuration for other SL operation than SL positioning;
bandwidth related configuration for a non-SL operation; or
time resource information associated with SL related bandwidth information.

12. (canceled)

31. A method performed by a User Equipment, UE, for providing sidelink, SL, related bandwidth information, the method comprising:
determining to provide SL related bandwidth information to a node, wherein the node is one of another UE, a radio network node, a core network node, or a UE positioning node or a network positioning node; and
providing the SL related bandwidth information to the node.

32. The method of claim 31, wherein the determining is based upon at least one of:
receiving a request from the node;
a trigger condition;
a timer;
a cell change;
engaging into SL positioning operation.

33. The method of claim 31, further comprising:
providing an update for the SL related bandwidth information to the node.

34. The method of claim 31, wherein the SL related bandwidth information comprises at least one of:
SL positioning bandwidth-related configuration;
bandwidth related configuration for other SL operation than SL positioning;
bandwidth related configuration for a non-SL operation; or
time resource information associated with SL related bandwidth information.

35-36. (canceled)

37. A method performed by a User Equipment, UE, for controlling interruptions in the UE due to a mismatch between sidelink, SL, related bandwidth configuration and uplink bandwidth related configuration, the method comprising:
comparing SL related bandwidth configuration and uplink bandwidth related configuration; and
in response to identifying a mismatch, performing at least one of:
providing SL related bandwidth information to a node;
performing an SL positioning operation while controlling an amount of interruptions to Uu operation associated with the UE; or
performing a Uu operation while controlling an amount of interruptions to SL positioning operation associated with the UE.

38. The method of claim 37, wherein the controlling the amount of interruptions to Uu operation associated with the UE comprises at least one of:
determining an actual amount;
determining an allowed or maximum amount;
ensuring that an allowed amount is not exceeded;
indicating at least one of an actual, expected, or allowed amount of interruptions to another node;
requesting reconfiguration of SL related bandwidth configuration to avoid or reduce an amount of interruptions to SL positioning;
indicating the mismatch when an amount of interruption exceeds a threshold;
requesting reconfiguration when an amount of interruption exceeds a threshold;
reporting a result of Uu operation while indicating Uu operation interruption occurrence and/or amount;
reporting an error to the Uu operation upon interruption occurrence or when an amount of interruptions exceeds a threshold.

39. The method of claim 37, wherein the controlling the amount of interruptions to SL positioning operation associated with the UE comprises at least one of:
determining an actual amount;
determining an allowed or maximum amount;
ensuring that an allowed amount is not exceeded;
indicating at least one of an actual, expected, or allowed amount of interruptions to another node;
requesting reconfiguration of SL related bandwidth configuration to avoid or reduce an amount of interruptions to SL positioning;
indicating the mismatch when an amount of interruption exceeds a threshold;
requesting reconfiguration when an amount of interruption exceeds a threshold;
reporting a result of SL positioning while indicating SL positioning operation interruption occurrence and/or amount;
reporting an error to the SL operation upon interruption occurrence or when an amount of interruptions exceeds a threshold.

40-41. (canceled)
